(19) United States
(12) Patent Application Publication
(10) Pub. No.: US 2025/0029767 A1
(43) Pub. Date: Jan. 23, 2025

(54) Magnetic Core

(71) Applicant: Enoda Ltd., London (GB)

(72) Inventor: Andrew John Scobie, London (GB)

(21) Appl. No.: 18/706,742

(22) PCT Filed: Oct. 28, 2022
(86) PCT No.: PCT/EP2022/080261

§ 371 Date: May 1, 2024

(30) Foreign Application Priority Data
Nov. 1, 2021 (GB) 2115649.2

(51) Int. Cl. H01F 27/245; H01F 27/26; H01F 30/12; H01F 41/02

(52) U.S. Cl. CPC H01F 27/2455; H01F 27/263; H01F 41/024; H01F 30/12

(57) ABSTRACT

Cores for electromagnetic devices are discussed. In one example, a core comprises three arc-shaped limbs. Each limb has a first end and a second end, and is arranged around a central axis. The first ends of the limbs are mutually connected at a first position along the central axis, and the second end of the limbs are mutually connected at a second position along the central axis. Each limb comprises a plurality of bent electrical steel strips. Methods for manufacturing such cores are also discussed.

### CROSS-REFERENCE TO RELATED APPLICATION INFORMATION

This application is a U.S. National Stage under 35 USC 371 of International Appln. No. PCT/EP2022/080261, published as WO2023/073203, which claims benefit of and priority to GB patent application No. GB2115649.2, filed 1 Nov. 2022, all of which are incorporated herein by reference in entirety.

### TECHNICAL FIELD

The following disclosure relates to magnetic cores for electromagnetic devices, and methods of manufacturing magnetic cores.

### BACKGROUND

Magnetic cores are utilised across a range of electromagnetic devices such as transformers, electric motors, generators, and inductors. For transformers, there are two types of construction: core-type and shell-type. The key distinction between the types lies in the core and winding placement. For core-type transformers, the windings encircle the core, while in shell-type transformers, the core encircles the windings.

In core-type single-phase transformers, the magnetic core is typically in the form of a closed square or rectangular ring made up of electrical steel laminations, with primary and secondary windings surrounding the core on opposite limbs of the ring. However, transformers with the primary and secondary coils on separate limbs generally see large flux leakages giving poor voltage regulation and poor overall performance.

Toroidal transformers are core-type single-phase transformers constructed with donut-shaped core. The primary and secondary windings of a toroidal transformer are typically wound across the entire surface of the core, separated by an insulating material. Some of the advantages of toroidal transformers include higher efficiency, inherent shielding from electromagnetic interference, minimal signal distortion, more compact construction, low mechanical humming, low heat, and small off-load losses.

Three-phase electric power is often used in power distribution systems. Three-phase power transformation requires either three single-phase transformers in a three-phase bank, or a three-phase transformer. An example magnetic core for a three-phase transformer 100 is discussed with reference to FIG. 1. The core 100 includes three substantially rectangular rings 102, each rectangular ring 102 having a first limb 104 and a second limb 106. Each of the first limbs 104 is wound with a primary winding and a secondary winding (not illustrated). The three rectangular rings 102 are mutually connected along the second limbs 106, and are spaced apart by 120 degrees. Each of the rectangular rings 102 comprises electrical steel rings 108 that are laminated together. Generally, each electrical steel ring 108 is cut from a sheet of electrical steel, leading to waste material, i.e. the centre of each electrical steel ring 108.

Further, in terms of performance, transformers incorporating cores such as core 100 are subject to power losses for example due to harmonic distortion and noise in power grids, in particular in low-voltage distribution grids, through the increased introduction of non-linear loads.

### SUMMARY

There is provided a core suitable for an electromagnetic device. The core may be suitable for electromagnetic devices such as transformers, electric motors, generators, and inductors etc. The core comprises three arc-shaped limbs. Each limb has a first end and a second end, and is arranged around a central axis. The first ends of the limbs are mutually connected at a first position along the central axis, and the second end of the limbs are mutually connected at a second position along the central axis. Each limb comprises a plurality of bent electrical steel strips.

The geometry of the core improves the matter-radiation interaction of the magnetic circuit and physical form, minimising the distribution of flux density and therefore minimising both saturation and dead spots of low flux density compared to a core with rectangular rings, such as core 100. This leads to a reduction in losses in the core and requires less core mass.

The electrical steel strips are bent into arc shapes that are laminated together, rather than, for example, planar arc shaped strips cut from a sheet of electrical steel being laminated together. This reduces the amount of waste material when forming the limbs.

The arc-shaped limbs may be semi-circular, i.e. having a measure of 180 degrees. In other examples, the arc-shaped limbs may be a minor arc, i.e. having a measure of less than 180 degrees. Alternatively, the arc-shaped limbs may be a major arc, i.e. having a measure of greater than 180 degrees.

The core may be suitable for a three-phase transformer. The core may include more than three arc-shaped limbs to accommodate for additional phases.

The electrical steel strips may be grain-oriented electrical steel. Bent arc-shaped grain-oriented electrical steel strips ensures that the grain orientation is maintained along the limbs, compared to, for example, planar arc shaped strips cut from a sheet of grain-oriented electrical steel. This maintains the symmetric behaviour of the limbs as optimal magnetic properties are found in the grain direction.

Each limb may be arranged equally-spaced around the central axis. For example, with a core consisting of three limbs, the limbs would be spaced apart by 120 degrees.

Each plurality of bent electrical steel strips may comprise a first group of strips, a second group of strips, and a third group of strips, wherein the first group of strips is arranged between the second group of strips and the third group of strips. The first group of strips may have a first thickness, the second group of strips may have a second thickness, the third group of strips may have a third thickness, and the first thickness may be greater than both the second thickness and the third thickness. The second thickness may be equal to the third thickness.

The first group of strips may consist of a first predetermined number of strips, the second group of strips may consist of a second predetermined number of strips, the third group of strips may consist of a third predetermined number of strips, and the first predetermined number of strips may be greater than both the second predetermined number of strips and the third predetermined number of strips. The second predetermined number of strips may be equal to the third predetermined number of strips.

The first group of strips may have a first width, the second group of strips may have a second width, the third group of strips may have a third width, and the first width may be greater than both the second width and the third width. The second width may be equal to the third width.

Each limb may be arranged to receive a respective primary winding and a respective secondary winding.

There is provided an electromagnetic device comprising the core described above, a respective primary winding arranged around each limb, and a respective secondary winding arranged around each limb. The electromagnetic device may be, for example, a transformer, an electric motor, a generator, or an inductor.

There is provided a method of manufacturing a core suitable for an electromagnetic device. The core may be suitable for electromagnetic devices such as transformers, electric motors, generators, and inductors etc. The method comprises forming, for example, by cutting, stamping or punching, three sets of strips from one or more sheets of electrical steel. Each set of strips comprises a plurality of strips, and the one or more sheets of electrical steel comprise an insulating surface layer. The method comprises arranging each of the three sets of strips into a respective stack, and bending each stack into an arc-shaped limb. Each limb has a first end and a second end. The method comprises positioning each limb around a central axis, mutually connecting the first ends of the limbs at a first position along the central axis, and mutually connecting the second ends of the limbs at a second position along the central axis.

As discussed above, bending the electrical steel strips rather than, for example, cutting planar arc shaped strips reduces the amount of waste material when forming the limbs.

The method may comprise, between the steps of bending each stack into an arc-shaped limb and mutually connecting the second ends of the limbs at the second position along the central axis, for each limb: applying a primary winding around the limb, and applying a second winding around the limb. Applying windings around the limbs may include winding a wire around the limb to form the winding. Alternatively, applying windings around the limbs may include spinning a wire onto a bobbin and inserting the limb into the bobbin. By winding the limbs prior to joining the limbs together, the winding process is simplified as the limbs have an open end.

Each limb may comprise a first group of strips, a second group of strips, and a third group of strips, wherein the first group of strips is arranged between the second group of strips and the third group of strips. The first group of strips may have a first thickness, the second group of strips may have a second thickness, the third group of strips may have a third thickness, and the first thickness may be greater than both the second thickness and the third thickness. The second thickness may be equal to the third thickness.

The first group of strips may consist of a first predetermined number of strips, the second group of strips may consist of a second predetermined number of strips, the third group of strips may consist of a third predetermined number of strips, and the first predetermined number of strips may be greater than both the second predetermined number of strips and the third predetermined number of strips. The second predetermined number of strips may be equal to the third predetermined number of strips.

The first group of strips may have a first width, the second group of strips may have a second width, the third group of strips may have a third width, and the first width may be greater than both the second width and the third width. The second width may be equal to the third width.

The method may comprise, between the steps of bending each stack into an arc-shaped limb and mutually connecting the first ends of the limbs at a first position along the central axis, for each limb: machining the first end to form a first edge for alignment with the central axis at the first position, the first edge having an inclusive angle of 120 degrees, and machining the second end to form a second edge for alignment with the central axis at the second position, the second edge having an inclusive angle of 120 degrees. Machining may comprise grinding, milling, sanding and/or cutting. Cutting may be by waterjet or laser. The inclusive angle is the angle between the outer sides of the ends. Machining the ends of the limbs enables a precise fit for the limbs to minimise potential air gaps in the connections at the first and second positions.

Positioning each limb around the central axis may comprise positioning each limb equally-spaced around the central axis.

The insulating surface layer may comprise a curable varnish, and the method may comprise, prior to positioning each limb around a central axis, curing the varnish in each limb.

Mutually connecting the first ends of the limbs and mutually connecting the second ends of the limbs may comprise using an adhesive. The adhesive may be a metal-to-metal structural adhesive. Examples of suitable metal-to-metal adhesives include: epoxy adhesives such as 3M EC-2216 B/A or Henkel MasterBond 11HT; paste adhesives such as 3M EC-9323 B/A; or structural adhesive films such as 3M AF31 or LOCTITE EA 9673 AERO. Mutually connecting the first ends of the limbs and mutually connecting the second ends of the limbs may comprise clamping the limbs together without an adhesive.

The method may comprise, prior to positioning each limb around a central axis, annealing each limb, for example, to improve the magnetic properties of the limb and to relieve internal mechanical stress in the limb.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding:

FIG. 1 is a schematic view of a three-phase magnetic core of the prior art;

FIG. 2A is a schematic view of a magnetic core;

FIG. 2B is a schematic exploded view of the magnetic core of FIG. 2A;

FIG. 2C is a schematic top view of the magnetic core of FIG. 2A;

FIG. 2D is a schematic front view of the magnetic core of FIG. 2A;

FIG. 2E is a table showing number of laminations in a limb of the magnetic core of FIG. 2A;

FIG. 3 is a schematic view of a magnetic core;

FIG. 4 is a flowchart of a process for manufacturing the core of a magnetic core; and

FIG. 5 is a schematic top view of a net for strips to be cut.

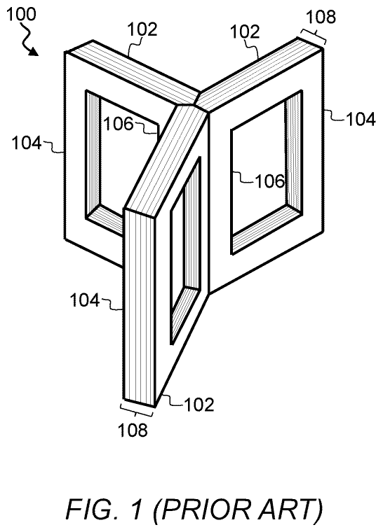

### DETAILED DESCRIPTION

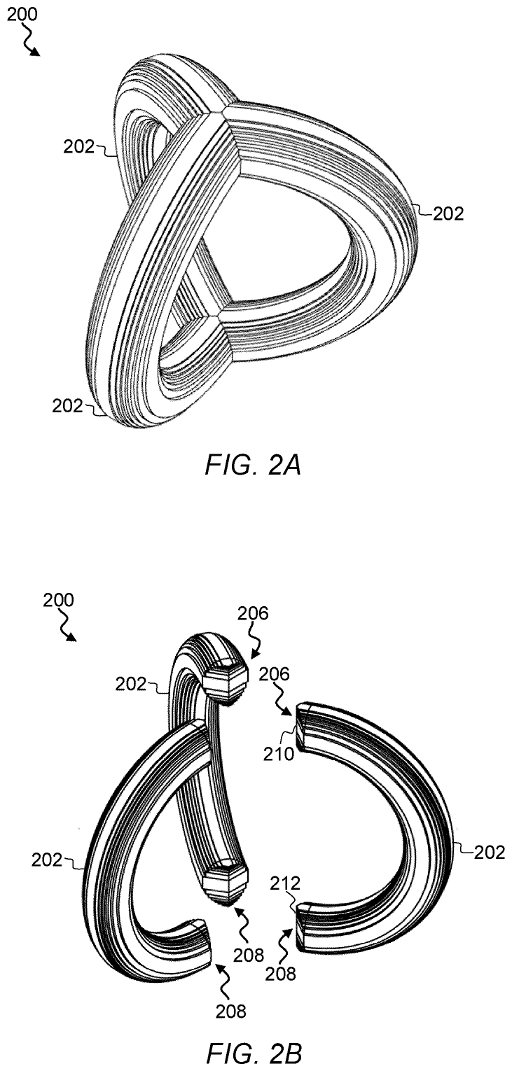

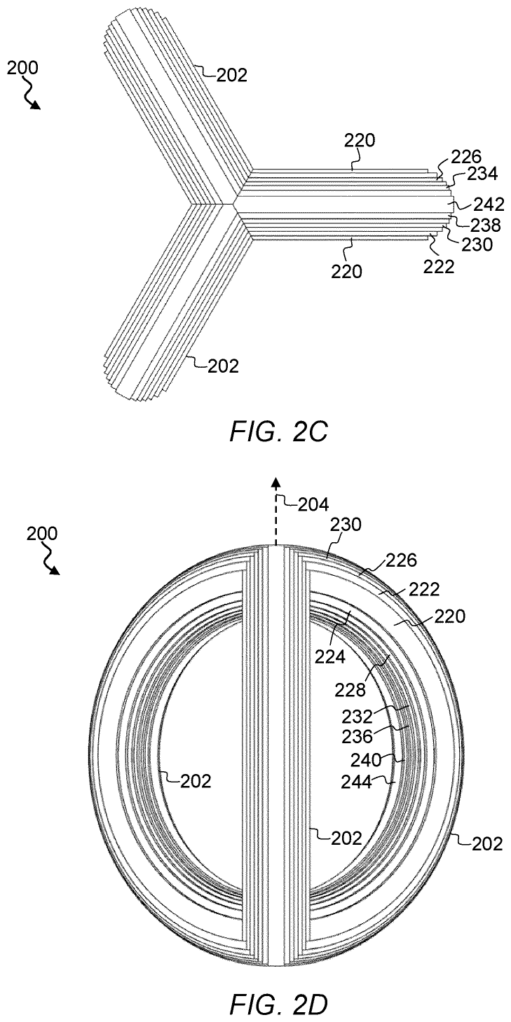

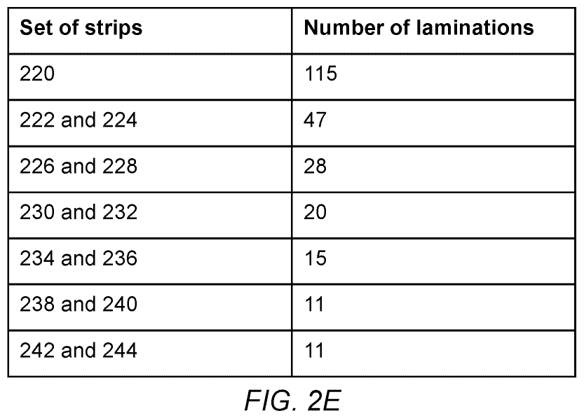

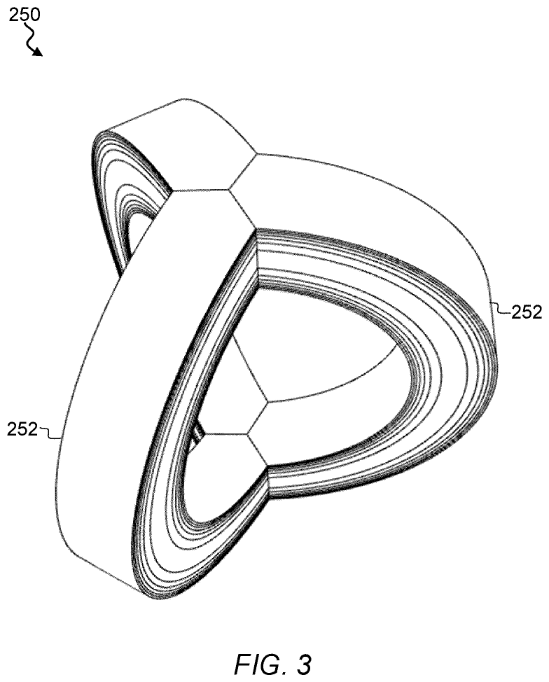

With reference to FIGS. 2A to 2D, a magnetic core 200 comprises three arc-shaped limbs 202 which are evenly spaced around a central axis 204. Each limb 202 is substantially identical. The arc-shaped limbs 202 are 180 degree arcs. Each limb has a first end 206 and a second end 208. Each first end 206 has a first edge 210 which lies along the central axis 204. Each second end 206 has a second edge 212 which lies along the central axis 204. The first ends 206 are joined together, and the second ends 208 are joined together. Each limb 202 may be wound with one or more of a primary, a secondary and a modulating winding (not illustrated).

Each limb 202 comprises a plurality of electrical steel strips that are bent and laminated together. The use of thin steel laminations reduces power losses caused by eddy currents induced when sinusoidal voltage is applied to the windings. The cross section of each limb approximates a circle by varying the widths of the strips in the limbs. The electrical steel strips of each limb 202 are grouped into fifteen sets of strips comprising a central set of strips 220, and sets of strips 222, 224, 226, 228, 230, 232, 234, 236, 238, 240, 242 and 244.

The sets of strips on either side of the central strip are paired, with each set of strips in a pair having substantially the same width and thickness. Set of strips 222 is paired with set of strips 224, arranged on either side of central set of strips 220. Set of strips 226 is paired with set of strips 228, with set of strips 226 arranged adjacent to set of strips 222 and set of strips 228 adjacent to set of strips 224. Set of strips 230 is paired with set of strips 232, with set of strips 230 arranged adjacent to set of strips 226 and set of strips 232 adjacent to set of strips 228. Set of strips 234 is paired with set of strips 236, with set of strips 234 arranged adjacent to set of strips 230 and set of strips 236 adjacent to set of strips 232. Set of strips 238 is paired with set of strips 240, with set of strips 238 arranged adjacent to set of strips 234 and set of strips 240 adjacent to set of strips 236. Set of strips 242 is paired with set of strips 244, with set of strips 242 arranged adjacent to set of strips 244 and set of strips 238 adjacent to set of strips 240.

The width of the sets of strips 222 and 224 is less than the width of the central set of strips 220. The width of the sets of strips 226 and 228 is less than the width of the sets of strips 222 and 224. The width of the sets of strips 230 and 232 is less than the width of the sets of strips 226 and 228. The width of the sets of strips 234 and 236 is less than the width of the sets of strips 230 and 232. The width of the sets of strips 238 and 240 is less than the width of the sets of strips 234 and 236. The width of the sets of strips 242 and 244 is less than the width of the sets of strips 238 and 240.

With reference to FIG. 2E, the thickness of each set of strips is affected by the number of strips, i.e. number of laminations of electric steel, in each set of strips. Each lamination may be between 0.2 millimetres and 0.5 millimetres in thickness. In core 200, the number of strips in the sets of strips 222 and 224 is fewer than the number of strips in central set of strips 220. The number of strips in the sets of strips 226 and 228 is fewer than the number of strips in the sets of strips 222 and 224. The number of strips in the sets of strips 230 and 232 is fewer than the number of strips in the sets of strips 226 and 228. The number of strips in the sets of strips 234 and 236 is fewer than the number of strips in the sets of strips 230 and 232. The number of strips in the sets of strips 238 and 240 is fewer than the number of strips in the sets of strips 234 and 236. The number of strips in the sets of strips 242 and 244 is the same as the number of strips in the sets of strips 238 and 240. In other examples, the number of strips in the sets of strips 242 and 244 may be fewer than the number of strips in the sets of strips 238 and 240.

The grouping of sets of strips used for the core 200 is one example of approximating a circular cross section and it is to be understood that many variations are possible. For example, each strip or laminate on either side of a central strip could have an incrementally smaller width to the central strip. Or there may be a different number of sets of strips. The number of sets of strips may be an odd number to enable symmetry of thickness and width of the sets of strips around a central set of strips.

FIG. 3 illustrates a core 250 which is substantially the same in configuration as core 200, e.g. having three arc-shaped limbs 252 which are evenly spaced around a central axis. Core 250 differs from core 200 in that the width of all of the electrical steel strips of the limbs 252 are the same. As such, the cross section of each limb is rectangular rather than approximating a circle.

In an alternative configuration, a magnetic core has substantially the same overall geometry as the magnetic core 200 but the arc-shaped limbs are formed from a plurality of planar arc shaped strips, rather than bent strips that may have been, for example, cut from a sheet of electrical steel. In other words, the orientation of the strips is perpendicular to that of the strips of the magnetic core 200.

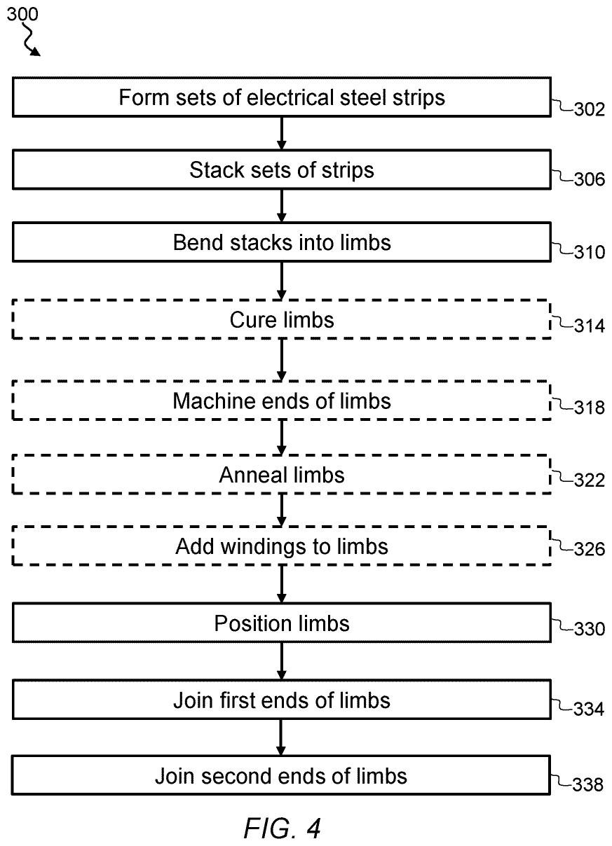

FIG. 4 illustrates a process 300 of manufacturing a core such as core 200. At step 302, sets of electrical steel strips are formed, one set of strips being for a limb of the core. The strips may be formed, for example, by punching, stamping or laser cutting the width and length of each strip out of a sheet of electrical steel. The electrical steel may be, for example, Thyseen-Krupp powercore® C or powercore® H.

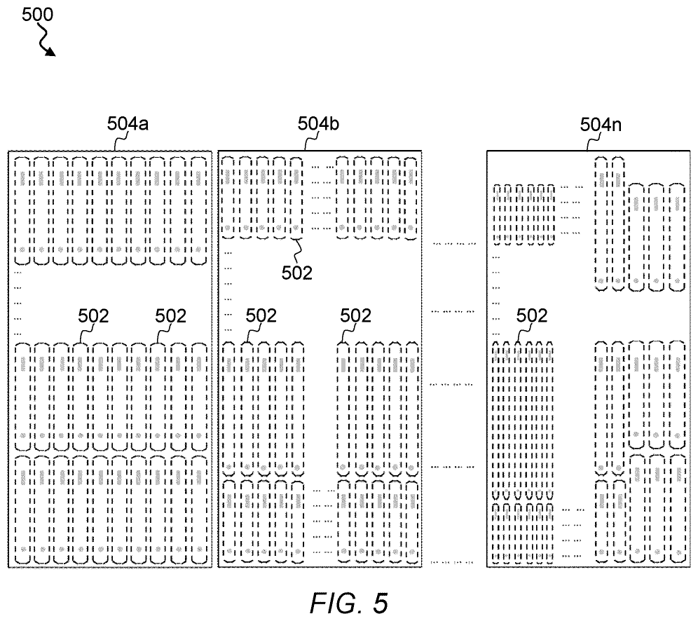

FIG. 5 illustrates an example set of templates 500 for cutting a plurality of strips 502 from sheets of electrical steel 504a, 504b, 504n.

Alternatively, lengths of strip can be cut from a roll of electrical steel having the same width as the strip. As discussed in relation to core 200, the strips in each set of electrical steel strips may have the same width, or the width of the strips may vary, for example, to approximate a circular cross section for the limb.

At step 306, each set of strips is arranged into a stack. At step 310, each stack is bent into an arc-shape limb, for example, using a jig. The stacks are bent through application of an external load in a direction perpendicular to a plane formed by the length and width of the strips.

The electrical steel strips may include a surface coating of electrically-insulating material. The surface coating may be curable, such as a varnish or paint. The curable surface coating in the stacks of strips may be cured at step 314. For example, the curable surface coating may be cured by heating the stacks in an autoclave. The electrically-insulating surface coating may be formed during annealing of the electrical steel strips. For example, the electrical steel strips may be subjected to annealing under an air atmosphere in a roller furnace for a soaking time of 1 to 2minutes at a maximum temperature of 860° C. Due to the air atmosphere, cut edges of the electrical steel strips oxidize, creating an insulating coating. A coating thickness of 2 to 5 micrometres provides good electrical resistance and a high stacking factor.

Each limb has a first end and a second end. At step 318, the ends of the limbs may be machined to produce angled ends which allow the limbs to mate tightly with each other. For example, if the core being manufactured has three limbs, the ends are machined to an angle of 120 degrees. The machining may include one or more of sanding, grinding, milling, and cutting, such as waterjet cutting or laser cutting. Alternatively or additionally to step 318, the strips may be formed at step 302 with angled ends. In some examples, the ends of the limbs may be machined to produce lap joints which allow the limbs to mate tightly with each other.

At step 322, the limbs may be annealed. If the curable surface coating is thermally cured at step 314, the annealing of step 322 may be included step 314. In some examples, the core may be annealed after the limbs are joined at step 334. The annealing may be magnetic annealing to improve the magnetic properties of the limb. Additionally or alternatively, the annealing may be stress relief annealing to relieve internal mechanical stress in the limb, for example, due to the bending in step 310. For example, the annealing may include a 2 hour soak in a box-type furnace with a protective atmosphere of preferably 100% nitrogen at between 820° C. and 850° C., followed by cooling within the furnace to about 200° C. to 300° C.

At step 326, one or more of a primary winding, a secondary winding and modulating windings may be applied to each limb. Applying windings to the limbs may be carried out at any point before both ends of each limb are connected together at step 338, in other words, when there is at least one open end. Applying windings around the limbs may include winding wire around a limb to form the winding. Alternatively, applying windings around the limbs may include spinning a wire onto a bobbin and inserting the limb into the bobbin. The winding process is simplified by winding the limbs prior to joining the limbs together. The windings may be distributed on the limbs with or without spacers.

At step 330, the limbs are positioned around a central axis. For example, the limbs may be held in position using clamps and/or a jig. At step 334, the first ends of the limbs are connected together. At step 338, the second ends of the limbs are connected together. Connecting the ends of the limbs together at steps 334 and 338 may include using an adhesive such as a metal-to-metal structural adhesive. Alternatively or additionally to connecting using an adhesive, connecting the ends of the limbs together at steps 334 and 338 may include clamping the limbs together. Steps 334 and 338 may be carried out simultaneously.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognise that various features of the described embodiments may be combined in accordance with the invention. In the claims, the term “comprising” or “including” does not exclude the presence of other elements.

1. A core suitable for an electromagnetic device, the core comprising three arc-shaped limbs wherein each limb is arranged around a central axis, and each limb has a first end and a second end, wherein the first ends of the limbs are mutually connected at a first position along the central axis, and the second end of the limbs are mutually connected at a second position along the central axis, and wherein each limb comprises a plurality of bent electrical steel strips.

2. The core of claim 1, wherein each limb is arranged equally-spaced around the central axis.

3. The core of any of claim 1 or 2, wherein each plurality of bent electrical steel strips comprises a first group of strips, a second group of strips, and a third group of strips, wherein the first group of strips is arranged between the second group of strips and the third group of strips.

4. The core of claim 3, wherein the first group of strips has a first thickness, the second group of strips has a second thickness, the third group of strips has a third thickness, and the first thickness is greater than both the second thickness and the third thickness.

5. The core of claim 4, wherein the second thickness is equal to the third thickness.

6. The core of any of claims 3 to 5, wherein the first group of strips has a first width, the second group of strips has a second width, the third group of strips has a third width, and the first width is greater than both the second width and the third width.

7. The core of claim 6, wherein the second width is equal to the third width.

8. The core of any of claims 1 to 7, wherein each is limb arranged to receive a respective primary winding and a respective secondary winding.

9. An electromagnetic device comprising:
the core of any of claims 1 to 8;
a respective primary winding arranged around each limb; and
a respective secondary winding arranged around each limb.

10. A method of manufacturing a core suitable for an electromagnetic device, the method comprising:
forming three sets of strips from one or more sheets of electrical steel, wherein each set of strips comprises a plurality of strips, and the one or more sheets of electrical steel comprise an insulating surface layer;
arranging each of the three sets of strips into a respective stack;
bending each stack into an arc-shaped limb, each limb having a first end and a second end;
positioning each limb around a central axis;
mutually connecting the first ends of the limbs at a first position along the central axis; and
mutually connecting the second ends of the limbs at a second position along the central axis.

11. The method of claim 10, comprising, between the steps of bending each stack into an arc-shaped limb and mutually connecting the second ends of the limbs at the second position along the central axis, for each limb:
applying a primary winding around the limb; and
applying a secondary winding around the limb.

12. The method of any of claim 10 or 11, wherein each limb comprises a first group of strips, a second group of strips, and a third group of strips, wherein the first group of strips is arranged between the second group of strips and the third group of strips.

13. The method of claim 12, wherein the first group of strips has a first thickness, the second group of strips has a second thickness, the third group of strips has a third thickness, and the first thickness is greater than both the second thickness and the third thickness.

14. The method of claim 13, wherein the second thickness is equal to the third thickness.

15. The method of any of claims 12 to 14, wherein the first group of strips has a first width, the second group of strips has a second width, the third group of strips has a third width, and the first width is greater than both the second width and the third width.

16. The method of claim 15, wherein the second width is equal to the third width.

17. The method of any of claims 10 to 16, comprising, between the steps of bending each stack into an arc-shaped limb and mutually connecting the first ends of the limbs at a first position along the central axis, for each limb:
machining the first end to form a first edge for alignment with the central axis at the first position, the first edge having an inclusive angle of 120 degrees; and
machining the second end to form a second edge for alignment with the central axis at the second position, the second edge having an inclusive angle of 120 degrees.

18. The method of any of claims 10 to 17, wherein positioning each limb around the central axis comprises positioning each limb equally-spaced around the central axis.

19. The method of any of claims 10 to 18, wherein the insulating surface layer comprises a curable varnish, the method comprising, prior to positioning each limb around a central axis, curing the varnish in each limb.

20. The method of any of claims 10 to 19, wherein mutually connecting the first ends of the limbs and mutually connecting the second ends of the limbs comprises using an adhesive.

21. The method of any of claims 10 to 20, comprising, prior to positioning each limb around a central axis, annealing each limb.
